(19) United States
(12) Patent Application Publication
(10) Pub. No.: US 2024/0195878 A1
(43) Pub. Date: Jun. 13, 2024

(54) APPLICATION MIGRATION METHOD AND APPARATUS, ELECTRONIC DEVICE, AND STORAGE MEDIUM

(71) Applicant: Alipay (Hangzhou) Information Technology Co., Ltd., Hangzhou (CN)

(72) Inventors: Qi ZHANG, Hangzhou (CN); Wei JIANG, Hangzhou (CN); Kai XU, Hangzhou (CN); Huasheng LIAO, Hangzhou (CN); Jianguo LI, Hangzhou (CN)

(21) Appl. No.: 18/530,959

(22) Filed: Dec. 6, 2023

(30) Foreign Application Priority Data
Dec. 7, 2022 (CN) 202211567230.7

(51) Int. Cl. H04L 67/148; H04L 65/40; H04L 67/1008

(52) U.S. Cl. CPC H04L 67/148; H04L 65/40; H04L 67/1008

(57) ABSTRACT

This specification discloses an application migration method and apparatus, an electronic device, and a storage medium. A to-be-migrated application included in a to-be-maintained server and all candidate servers that receive the to-be-migrated application can be determined. For each to-be-migrated application, an application container configured to maintain the to-be-migrated application is determined. A migration constraint between all to-be-migrated applications and all the candidate servers is determined. Finally, a server that receives each to-be-migrated application is determined from all the candidate servers when the migration constraint is satisfied and a quantity of servers configured to receive the to-be-migrated application meets a preset requirement, and for each to-be-migrated application, an application container of the to-be-migrated application is migrated to a server corresponding to the to-be-migrated application. A constraint condition is introduced into application migration, to reduce application migration costs, and protect privacy data of a user.

### TECHNICAL FIELD

This specification relates to the field of computer technologies, and in particular, to an application migration method and apparatus, an electronic device, and a storage medium.

### BACKGROUND

Currently, in a hybrid deployment technology, different applications can be deployed on the same server, to fully use idle resources of the server. In addition, purchase costs of a device can be further reduced, and privacy data of a user is protected.

In an actual application, when a server to which the hybrid deployment technology is applied needs to be upgraded, an application container in which an application runs in the server needs to be migrated to another server, to empty the server. However, in the conventional technology, usually, migration between servers cannot be effectively performed, leading to resource waste.

### SUMMARY

This specification provides an application migration method and apparatus, an electronic device, and a storage medium, to ensure that application migration performed for a hybrid deployment server is proper.

This specification provides an application migration method, including:
determining a to-be-migrated application included in a to-be-maintained server and all candidate servers that receive the to-be-migrated application;
for each to-be-migrated application, determining an application container configured to maintain the to-be-migrated application;
determining a migration constraint between all to-be-migrated applications and all the candidate servers; and
determining, from all the candidate servers when the migration constraint is satisfied and a quantity of servers configured to receive the to-be-migrated application meets a preset requirement, a server that receives each to-be-migrated application, and for each to-be-migrated application, migrating an application container of the to-be-migrated application to a server corresponding to the to-be-migrated application.

Optionally, the determining each candidate server that receives the to-be-migrated application includes:
determining, as the candidate server that receives the to-be-migrated application, a server that matches a server configuration of the to-be-maintained server.

Optionally, the determining a migration constraint between all to-be-migrated applications and all the candidate servers includes:
for each to-be-migrated application, determining, based on configuration information of each candidate server as a mutually exclusive server corresponding to the to-be-migrated application, a candidate server that does not match the to-be-migrated application; and
determining the migration constraint between all the to-be-migrated applications and the candidate servers based on the mutually exclusive server corresponding to the to-be-migrated application.

Optionally, before the determining, from all the candidate servers when the migration constraint is satisfied and a quantity of servers configured to receive the to-be-migrated application meets a preset requirement, a server that receives each to-be-migrated application, the method further includes:
determining a service constraint existing between all the to-be-migrated applications; and
the determining, from all the candidate servers when the migration constraint is satisfied and a quantity of servers configured to receive the to-be-migrated application meets a preset requirement, a server that receives each to-be-migrated application includes:
when the migration constraint and the service constraint are satisfied and the quantity of servers configured to receive the to-be-migrated application meets the preset requirement, determining, from all the candidate servers, the server that receives each to-be-migrated application.

Optionally, the determining a service constraint existing between all the to-be-migrated applications includes:
determining a service peak period corresponding to each to-be-migrated application;
for each to-be-migrated application, determining a mutually exclusive application corresponding to the to-be-migrated application based on the service peak period corresponding to each to-be-migrated application; and
determining the service constraint between all the to-be-migrated applications based on mutually exclusive applications corresponding to all the to-be-migrated applications.

Optionally, the determining, from all the candidate servers when the migration constraint is satisfied and a quantity of servers configured to receive the to-be-migrated application meets a preset requirement, a server that receives each to-be-migrated application, and for each to-be-migrated application, migrating an application container of the to-be-migrated application to a server corresponding to the to-be-migrated application includes:
determining some to-be-migrated applications from all the to-be-migrated applications as target applications;
when the migration constraint is met, determining a candidate server that receives the target application, and migrating, to the candidate server corresponding to the target application, an application container in which the target application is located, to minimize a quantity of servers configured to receive the target application; and
continuing to determine some to-be-migrated applications from the remaining applications in the to-be-migrated applications and use the some to-be-migrated applications as new target applications, and when the migration constraint is met, determining a candidate server that receives the target application, and migrating an application container of the target application to a candidate server corresponding to the target application, to minimize a quantity of servers configured to receive the to-be-migrated application, until all the to-be-migrated applications are migrated to the candidate servers.

This specification provides an application migration apparatus, including:
a server determining module, configured to determine a to-be-migrated application included in a to-be-maintained server and all candidate servers that receive the to-be-migrated application;
a container determining module, configured to: for each to-be-migrated application, determine an application container configured to maintain the to-be-migrated application;
a constraint determining module, configured to determine a migration constraint between all to-be-migrated applications and all the candidate servers; and
a migration module, configured to: determine, from all the candidate servers when the migration constraint is satisfied and a quantity of servers configured to receive the to-be-migrated application meets a preset requirement, a server that receives each to-be-migrated application, and for each to-be-migrated application, migrate an application container of the to-be-migrated application to a server corresponding to the to-be-migrated application.

Optionally, the server determining module is specifically configured to determine, as the candidate server that receives the to-be-migrated application, a server that matches a server configuration of the to-be-maintained server.

Optionally, the constraint determining module is specifically configured to: for each to-be-migrated application, determine, based on configuration information of each candidate server as a mutually exclusive server corresponding to the to-be-migrated application, a candidate server that does not match the to-be-migrated application; and determine the migration constraint between all the to-be-migrated applications and the candidate servers based on the mutually exclusive server corresponding to the to-be-migrated application.

Optionally, before the server that receives each to-be-migrated application is determined from all the candidate servers when the migration constraint is satisfied and a quantity of servers configured to receive the to-be-migrated application meets a preset requirement, the constraint determining module is further configured to determine a service constraint existing between all the to-be-migrated applications; and

the migration module is specifically configured to: when the migration constraint and the service constraint are satisfied and the quantity of servers configured to receive the to-be-migrated application meets the preset requirement, determine, from all the candidate servers, the server that receives each to-be-migrated application.

Optionally, the constraint determining module is further configured to: determine a service peak period corresponding to each to-be-migrated application; for each to-be-migrated application, determine a mutually exclusive application corresponding to the to-be-migrated application based on the service peak period corresponding to each to-be-migrated application; and determine the service constraint between all the to-be-migrated applications based on mutually exclusive applications corresponding to all the to-be-migrated applications.

Optionally, the migration module is specifically configured to: determine some to-be-migrated applications from all the to-be-migrated applications as target applications; when the migration constraint is met, determine a candidate server that receives the target application, and migrate, to the candidate server corresponding to the target application, an application container in which the target application is located, to minimize a quantity of servers configured to receive the target application; and continue to determine some to-be-migrated applications from the remaining applications in the to-be-migrated applications and use the some to-be-migrated applications as new target applications, and when the migration constraint is met, determine a candidate server that receives the target application, and migrating an application container of the target application to a candidate server corresponding to the target application, to minimize a quantity of servers configured to receive the target application, until all the to-be-migrated applications are migrated to the candidate servers.

This specification provides a non-transitory computer-readable storage medium. The storage medium stores a computer application, and when the computer application is executed by a processor, the application migration method is implemented.

This specification provides an electronic device, including a memory, a processor, and a computer application that is stored in the memory and that is capable of running on the processor. When the processor executes the application, the application migration method is implemented.

In the application migration method provided in this specification, a to-be-migrated application included in a to-be-maintained server and all candidate servers that receive the to-be-migrated application can be determined. For each to-be-migrated application, an application container configured to maintain the to-be-migrated application is determined. A migration constraint between all to-be-migrated applications and all the candidate servers is determined. Finally, a server that receives each to-be-migrated application is determined from all the candidate servers when the migration constraint is satisfied and a quantity of servers configured to receive the to-be-migrated application meets a preset requirement, and for each to-be-migrated application, an application container of the to-be-migrated application is migrated to a server corresponding to the to-be-migrated application.

It can be learned from the above-mentioned content that, when there is a to-be-migrated application that needs to be migrated, a service platform can determine the migration constraint between the to-be-migrated applications and all the candidate servers, and calculate, by using the migration constraint as a constraint condition, how to allocate the to-be-migrated applications to the candidate servers, so that a quantity of candidate servers used for migration of the to-be-migrated application meets a specific requirement (for example, as few as possible), thereby reducing application migration costs and satisfying a constraint condition needed by a resource or a service in application migration.

### BRIEF DESCRIPTION OF DRAWINGS

The accompanying drawings described here are used to provide a further understanding of this specification, and constitute a part of this specification. Example embodiments of this specification and descriptions of the embodiments are used to explain this specification, and do not constitute an inappropriate limitation on this specification. In the accompanying drawings:

FIG. 1 is a schematic flowchart illustrating an application migration method, according to this specification;

FIG. 2 is a schematic flowchart illustrating multi-round migration of a to-be-migrated application, according to this specification;

FIG. 3 is a schematic flowchart illustrating determining of a candidate server of a to-be-migrated application in a single round, according to this specification;

FIG. 4 is a schematic diagram illustrating an application migration apparatus, according to this specification; and

FIG. 5 is a schematic diagram illustrating an electronic device corresponding to FIG. 1, according to this specification.

### DESCRIPTION OF EMBODIMENTS

To enable a person skilled in the art to practice one or more embodiments of this specification, the following clearly and comprehensively describes the technical solutions of this specification with reference to specific embodiments and accompanying drawings of this specification. Clearly, the described embodiments are merely some but not all of the embodiments of this specification. All other embodiments obtained by a person of ordinary skill in the art based on embodiments of this specification without creative efforts shall fall within the protection scope of this specification.

The technical solutions provided in the embodiments of this specification are described in detail below with reference to the accompanying drawings.

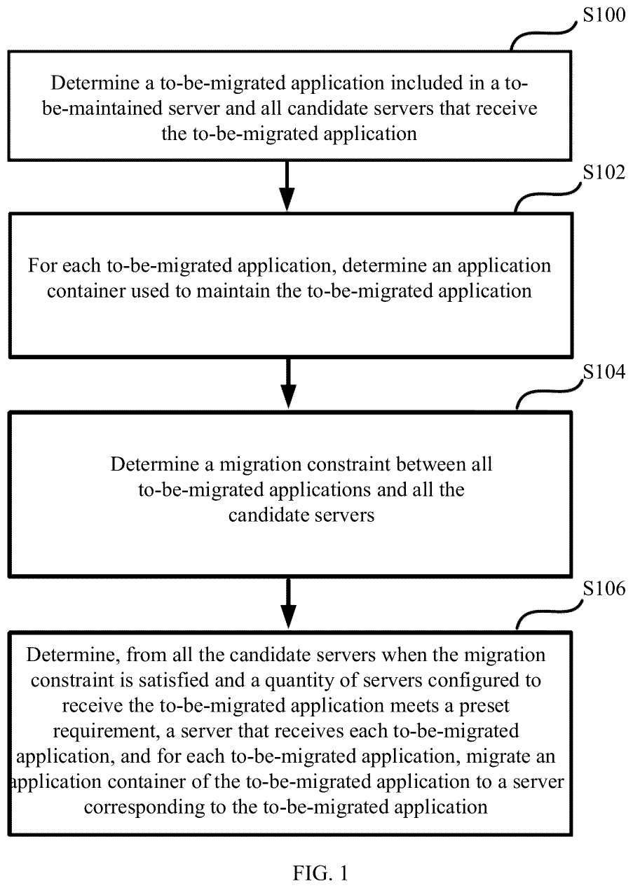

FIG. 1 is a schematic flowchart illustrating an application migration method, according to this specification. The following steps are specifically included.

S100: Determine a to-be-migrated application included in a to-be-maintained server and all candidate servers that receive the to-be-migrated application.

In an actual application, for a server to which a hybrid deployment technology is applied, applications corresponding to a plurality of different services can usually run on one server. Each application can be maintained by an application container corresponding to the application. In other words, the application runs in the application container corresponding to the application. When the server needs to be upgraded, the application container in the server needs to be emptied.

Based on this, a service platform needs to determine the to-be-migrated application included in the to-be-maintained server and all candidate servers that receive the to-be-migrated application. There can be a plurality of to-be-maintained servers, and there may be a plurality of to-be-migrated applications in each to-be-maintained server. In other words, there may be a plurality of application containers in each to-be-maintained server. Application containers included in all to-be-maintained servers need to be emptied. To be specific, the application containers in all the to-be-maintained servers need to be migrated to all the candidate servers. In this case, a solution to allocate the application containers in all the to-be-maintained servers to the candidate servers needs to be determined.

To avoid a potential safety hazard (for example, incompatibility) that occurs in an application migration process, a server that matches a server configuration of the to-be-maintained server can be determined as the candidate server that receives the to-be-migrated application. Matching the server configuration mentioned here can be that a server configuration is not second to the server configuration of the to-be-maintained server, and can be specifically that the server configuration is consistent with the server configuration of the to-be-maintained server; or is that the server configuration is higher than the server configuration of the to-be-maintained server. For example, a server whose server model is consistent with a server model of the to-be-maintained server can serve as the candidate server.

It should be noted that, in actual application migration, there may be many to-be-maintained servers, and configurations (or models) of these to-be-maintained servers are different. In this case, all the to-be-maintained servers and all the candidate servers can be grouped based on a model, and a to-be-maintained server and a candidate server that have the same model are in the same group. When the candidate server corresponding to the to-be-migrated application in the to-be-maintained server is determined, the candidate server is determined from a candidate server in the same group. In other words, the to-be-migrated application in the to-be-maintained server is migrated to a candidate server in the same group.

In an actual application, when determining a specific to-be-maintained server and a specific to-be-migrated application that exist, the service platform can obtain identification information (for example, an IP address) corresponding to the to-be-maintained server and identification information (for example, an IP address) of the candidate server, and obtain server information and container information (which can be understood as container information corresponding to each application) that are online, and distribution information of all to-be-migrated applications deployed on all servers (indicating a case of application containers deployed on all the servers).

Then, based on the identification information corresponding to the to-be-maintained server and identification information of each candidate server, information needed for current application migration can be selected from the server information, the container information, and the distribution information of all the to-be-migrated applications deployed on all the servers. Specifically, the information can specifically include related information (such as configuration information and a security level) of the to-be-maintained server, a to-be-migrated application deployed on each to-be-maintained server, related information of the to-be-migrated application, and the like. The information can be used to subsequently determine that a specific to-be-migrated application can be migrated to a specific candidate server.

S102: For each to-be-migrated application, determine an application container configured to maintain the to-be-migrated application.

S104: Determine a migration constraint between all the to-be-migrated applications and all the candidate servers.

S106: Determine, from all the candidate servers when the migration constraint is satisfied and a quantity of servers configured to receive the to-be-migrated application meets a preset requirement, a server that receives each to-be-migrated application, and for each to-be-migrated application, migrate an application container of the to-be-migrated application to a server corresponding to the to-be-migrated application.

After the candidate server is determined, for each to-be-migrated application, the application container configured to maintain the to-be-migrated application can be determined, and the migration constraint between all the to-be-migrated applications and all the candidate servers is determined. Therefore, the server that receives each to-be-migrated application can be determined from all the candidate servers when the migration constraint is satisfied and the quantity of servers configured to receive the to-be-migrated application meets the preset requirement, and for each to-be-migrated application, the application container of the to-be-migrated application is migrated to the server corresponding to the to-be-migrated application.

There can be a plurality of preset requirements, and the preset requirement can be that minimizing the quantity of servers configured to receive each to-be-migrated application is a target. Certainly, the preset requirement can be that the quantity of servers configured to receive the to-be-migrated application falls within a preset interval range, and the preset interval range mentioned here can be preset manually.

In this specification, the migration constraint, a resource constraint that the quantity of servers configured to receive the to-be-migrated application meets the preset requirement (for example, minimizing the quantity of servers configured to receive the to-be-migrated application), and a subsequently mentioned service constraint between all to-be-migrated applications can be all represented as an integer linear programming problem, and can be solved in a branch and bound method, to determine a candidate server corresponding to each to-be-migrated application.

It should be noted that the migration constraint between all the to-be-migrated applications and all the candidate servers can be a constraint that the to-be-migrated application can be or cannot be migrated to some servers. Specifically, there can be a plurality of migration constraint determining manners. For example, for each to-be-migrated application, a candidate server that does not match the to-be-migrated application can be determined based on configuration information of each candidate server as a mutually exclusive server corresponding to the to-be-migrated application; and the migration constraint between all the to-be-migrated applications and the candidate servers is determined based on the mutually exclusive server corresponding to the to-be-migrated application.

That is, based on a configuration of each candidate server, a candidate server that is not applicable to the to-be-migrated application can be determined, so that the candidate server serves as a mutually exclusive server of the to-be-migrated application. That the migration constraint between all the to-be-migrated applications and the candidate servers is determined by using the mutually exclusive server corresponding to each to-be-migrated application can mean that, it is defined in the migration constraint that the application container of the to-be-migrated application does not need to be migrated to the mutually exclusive server of the to-be-migrated application.

For another example, for each to-be-migrated application, the mutually exclusive server corresponding to the to-be-migrated application can be determined based on a security level of each candidate server and a security requirement corresponding to the to-be-migrated application, and the migration constraint between all the to-be-migrated applications and the candidate servers is determined based on the mutually exclusive server corresponding to each to-be-migrated application.

For example, different to-be-migrated applications may need to be deployed in candidate servers at different security levels. Therefore, during migration, a mutually exclusive server to which the to-be-migrated application cannot be migrated can also be determined based on a security requirement of the to-be-migrated application and a security level of each candidate server, to establish the migration constraint between the to-be-migrated applications and the candidate servers.

In addition to the above-mentioned constraint, the service constraint between all the to-be-migrated applications can be further introduced. Specifically, the service constraint existing between all the to-be-migrated applications can be determined, and when the migration constraint and the service constraint are satisfied and the quantity of servers configured to receive the to-be-migrated application meets the preset requirement, the server that receives each to-be-migrated application is determined from all the candidate servers. The service constraint mentioned here can indicate a constraint condition for to-be-migrated applications that do not need to be migrated to the same server.

Specifically, there can also be a plurality of service constraint determining manners.

Specifically, a service peak period corresponding to each to-be-migrated application can be determined; for each to-be-migrated application, a mutually exclusive application corresponding to the to-be-migrated application is determined based on the service peak period corresponding to each to-be-migrated application; and the service constraint between all the to-be-migrated applications is determined based on mutually exclusive applications corresponding to all the to-be-migrated applications.

In other words, to-be-migrated applications that conflict with each other in the service peak period, for example, that are the same as or similar to each other in the service peak period serve as mutually exclusive applications, and the mutually exclusive applications do not need to be migrated to the same server.

For another example, if there is a resource conflict between to-be-migrated applications, the to-be-migrated applications can also serve as mutually exclusive applications. In other words, if support of the same resource in a server is needed in running processes of two to-be-migrated applications, the two to-be-migrated applications can serve as mutually exclusive applications.

As mentioned in the above-mentioned content, the migration constraint, the service constraint, and the resource constraint (that is, minimizing the quantity of servers configured to receive the to-be-migrated application) can be all represented as an integer linear programming problem, and can be specifically represented as the following formula (can be solved in the branch and bound method).

Resource constraint:

$$\begin{matrix}Loss = Min {\sum }_{j = 1}^{m} {Y}_{j} \\ Subject to : {\sum }_{{j = 1}^{}}^{m} {X}_{ij} = 1 , i = 1 , … , n\end{matrix}$$

Here, both Xᵢⱼ and Yⱼ are variables whose values are 0 or 1, Xᵢⱼ is used to indicate whether the i^{th} to-be-migrated application is migrated to the j^{th} candidate server, and Yⱼ is used to indicate whether the j^{th} candidate server is enabled, that is, indicates whether the j^{th} candidate server is used for application migration. The resource constraint means that each value of Xᵢⱼ is calculated to minimize a sum corresponding to each candidate server, and a constraint on each value of Xᵢⱼ is that, for any to-be-migrated application, a sum of the values of Xᵢⱼ corresponding to the to-be-migrated application is 1, that is, the to-be-migrated application can be migrated to only one candidate server.

There can be a plurality of conditions for enabling the candidate server. For example, when it is determined that a quantity of to-be-migrated applications that need to be migrated in the candidate server reaches a preset allowed quantity of the server, the candidate server can serve as an enabled server. For another example, when it is determined that the to-be-migrated application that needs to be migrated in the to-be-migrated server occupies a resource with a preset size or a preset type in the candidate server, the to-be-migrated server can serve as an enabled server.

Migration constraint:

Xᵢⱼ=0

It can be learned that, if a migration constraint exists between the to-be-migrated application and the candidate server, Xᵢⱼ can be directly set to 0.

Service constraint:

When the service constraint is determined, the service constraint can be modeled as the following formula:

$${V}_{i j k} = min \{ {X}_{\dot{ι} k} , {X}_{j k} \} , {V}_{ij} = {\sum }_{k = 1}^{m} {V}_{i j k} , {V}_{i j} = 0 , ( i , j ) ∈ M$$

Here, M is a set of mutually exclusive application pairs. In other words, the set M includes a plurality of pairs of mutually exclusive applications. The formula can be represented as follows: When a pair of to-be-migrated applications (a to-be-migrated application i and a to-be-migrated application j) is in M, Xᵢₖ and Xⱼₖ that correspond to the pair of to-be-migrated applications cannot be both 1 for the k^{th} candidate server. That is, the formula expects to represent a pair of to-be-migrated applications (the to-be-migrated application i and the to-be-migrated application j) that serve as mutually exclusive applications, and the pair of to-be-migrated applications is not migrated to the same candidate server.

However, it can be learned that a variable Vik including three dimensions exists in the formula. Therefore, when the variable is solved, time is too long and efficiency is low. Therefore, in an actual application, a service constraint can be converted into the following formula:

Aⱼ∈{0,1},Xᵢⱼ≤Aⱼ,i∈C;Xᵢⱼ≤1−Aⱼ,i∉C

Here, Aⱼ is a variable whose value is 0 or 1, and C represents a set of to-be-migrated applications. The to-be-migrated applications in the set can be migrated to the same candidate server, and to-be-migrated applications that do not belong to the set cannot be migrated to the same candidate server as to-be-migrated applications in the set.

Each candidate server corresponds to one value of Aⱼ. A to-be-migrated application that belongs to the set C can be migrated to a candidate server whose Aⱼ is 1, and only a to-be-migrated application that does not belong to the set C is allowed to be migrated to a candidate server whose Aⱼ is 0. Therefore, the service constraint expects to express that the to-be-migrated application that belongs to the set C can be migrated to the candidate server whose Aⱼ is 1, but the to-be-migrated application that does not belong to the set C cannot be migrated to the candidate server whose Aⱼ is 1.

It should be noted that, an application migration process in the method can be performed in a plurality of rounds. That is, the above-mentioned description only describes that in the application migration method, how to allocate the candidate servers to the to-be-migrated applications can be determined by using several constraints. In an actual application, how to allocate the candidate servers to the to-be-migrated applications can be calculated in batches, to improve calculation efficiency and reduce computation difficulty.

Specifically, some to-be-migrated applications can be determined from all the to-be-migrated applications as target applications; and a candidate server that receives the target application is determined, and an application container that maintains the target application is migrated to the candidate server corresponding to the target application, to satisfy the migration constraint (and the service constraint) and minimize a quantity of servers configured to receive the target application. Then, some to-be-migrated applications continue to be determined from the remaining applications in the to-be-migrated applications and are used as new target applications, and a candidate server that receives the target application is determined, and an application container of the target application is migrated to a candidate server corresponding to the target application, to satisfy the migration constraint, and minimize a quantity of servers configured to receive the target application, until all the to-be-migrated applications are migrated to the candidate servers.

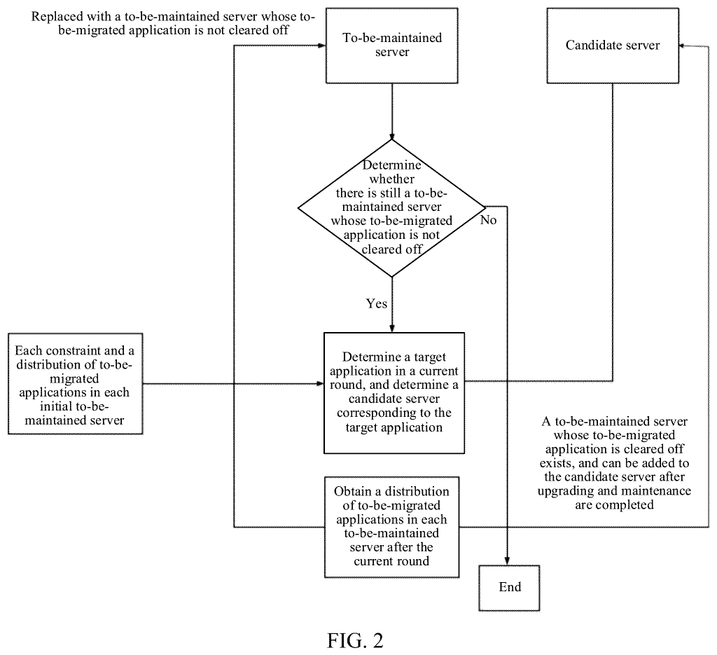

In other words, a process of determining how to migrate all the to-be-migrated applications to all the candidate servers can be performed in a plurality of rounds. Some to-be-migrated applications is first determined, and a candidate server to which the some to-be-migrated applications need to be migrated is determined based on the three constraints. After the some to-be-migrated applications is migrated, some to-be-migrated applications that is not migrated is determined, and a candidate server to which the some to-be-migrated applications needs to be migrated continues to be determined, until all the to-be-migrated applications are migrated, as shown in FIG. 2.

FIG. 2 is a schematic flowchart illustrating multi-round migration of a to-be-migrated application, according to this specification.

It can be learned from FIG. 2 that, in multi-round migration, whether there is a to-be-maintained server whose to-be-migrated application is not cleared off can be first determined; if there is a to-be-maintained server whose to-be-migrated application is not cleared off, one round of a process of determining a candidate server corresponding to target applications (the target applications are some to-be-migrated applications, a specified quantity of applications can be determined from the to-be-migrated applications as the target applications) is performed; and a to-be-maintained server whose to-be-migrated application is cleared off in the round can be upgraded and maintained, and the upgraded and maintained to-be-maintained server can serve as a candidate server that receives the to-be-migrated application. Then, the above-mentioned process is circulated, to determine whether there is still a to-be-maintained server whose to-be-migrated application is not cleared off, and if there is a to-be-maintained server whose to-be-migrated application is not cleared off, a new round of the process of determining a candidate server corresponding to the target application is performed; or if there is no to-be-maintained server whose to-be-migrated application is not cleared off, current application migration is finished.

It should be noted that, because there may be a small quantity of candidate servers and a large quantity of to-be-maintained servers, when application migration of some to-be-migrated applications in one round is completed, there may be some to-be-maintained servers whose to-be-migrated applications are cleared off. In this case, upgrading and maintenance of these to-be-maintained servers can be completed, and an upgraded and maintained to-be-maintained server serves as a candidate server, and can be configured to receive to-be-migrated applications in the remaining to-be-maintained servers in a next round.

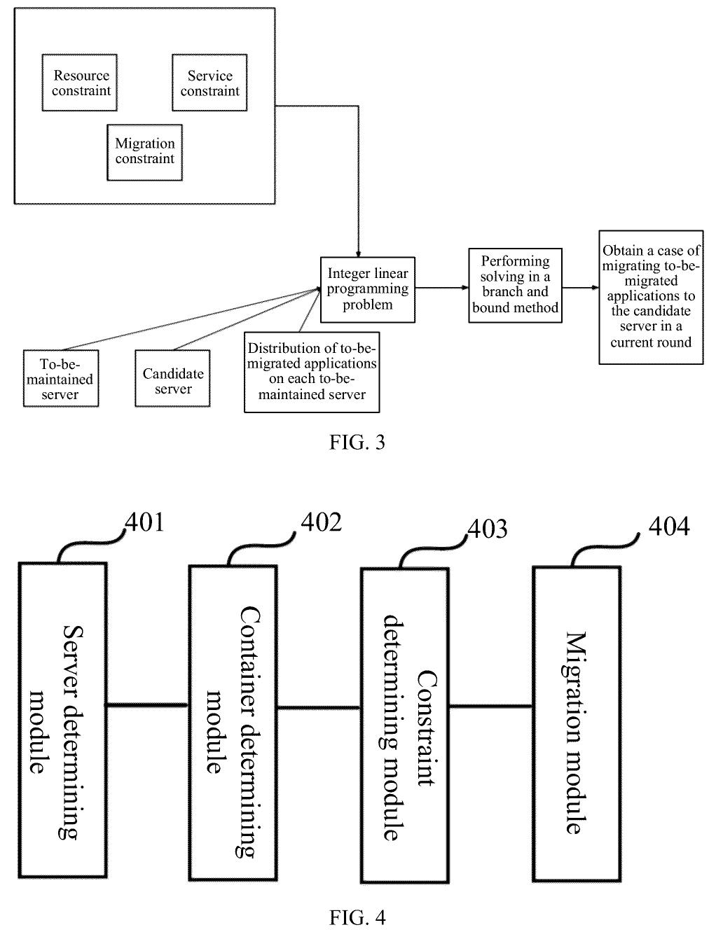

Manners of determining the candidate server of the to-be-migrated application in all rounds are the same, as shown in FIG. 3.

FIG. 3 is a schematic flowchart illustrating determining of a candidate server of a to-be-migrated application in a single round, according to this specification. It can be learned from FIG. 3 that, in a process of determining the candidate server of the to-be-migrated application in one round, the resource constraint, the service constraint, and the migration constraint can be converted into an integer linear programming problem by using a to-be-maintained server that needs to perform application migration and a candidate server that is configured to receive the to-be-migrated application, and a candidate server corresponding to each to-be-migrated application is solved in the branch and bound method.

It can be learned from the above-mentioned content that, when there is a to-be-migrated application that needs to be migrated, the service platform can determine the migration constraint between the to-be-migrated applications and all the candidate servers and the service constraint existing between all the to-be-migrated applications, and calculate, by using the migration constraint and the service constraint as a constraint condition, how to allocate the to-be-migrated applications to the candidate servers, to reduce the quantity of candidate servers used for migration of the to-be-migrated application, thereby reducing application migration costs and satisfying a constraint condition needed by a resource or a service in application migration.

The application migration method provided in one or more embodiments of this specification is described above. Based on the same idea, this specification further provides an application migration apparatus, as shown in FIG. 4.

FIG. 4 is a schematic diagram illustrating an application migration apparatus, according to this specification. The apparatus specifically includes:
a server determining module 401, configured to determine a to-be-migrated application included in a to-be-maintained server and all candidate servers that receive the to-be-migrated application;
a container determining module 402, configured to: for each to-be-migrated application, determine an application container configured to maintain the to-be-migrated application;
a constraint determining module 403, configured to determine a migration constraint between all to-be-migrated applications and all the candidate servers; and
a migration module 404, configured to: determine, from all the candidate servers when the migration constraint is satisfied and a quantity of servers configured to receive the to-be-migrated application meets a preset requirement, a server that receives each to-be-migrated application, and for each to-be-migrated application, migrate an application container of the to-be-migrated application to a server corresponding to the to-be-migrated application.

Optionally, the server determining module 401 is specifically configured to determine, as the candidate server that receives the to-be-migrated application, a server that matches a server configuration of the to-be-maintained server.

Optionally, the constraint determining module 403 is specifically configured to: for each to-be-migrated application, determine, based on configuration information of each candidate server as a mutually exclusive server corresponding to the to-be-migrated application, a candidate server that does not match the to-be-migrated application; and determine the migration constraint between all the to-be-migrated applications and the candidate servers based on the mutually exclusive server corresponding to the to-be-migrated application.

Optionally, before the server that receives each to-be-migrated application is determined from all the candidate servers when the migration constraint is satisfied and a quantity of servers configured to receive the to-be-migrated application meets a preset requirement, the constraint determining module 403 is further configured to determine a service constraint existing between all the to-be-migrated applications; and the migration module 404 is specifically configured to: when the migration constraint and the service constraint are satisfied and the quantity of servers configured to receive the to-be-migrated application meets the preset requirement, determine, from all the candidate servers, the server that receives each to-be-migrated application.

Optionally, the constraint determining module 403 is further configured to: determine a service peak period corresponding to each to-be-migrated application; for each to-be-migrated application, determine a mutually exclusive application corresponding to the to-be-migrated application based on the service peak period corresponding to each to-be-migrated application; and determine the service constraint between all the to-be-migrated applications based on mutually exclusive applications corresponding to all the to-be-migrated applications.

Optionally, the migration module 404 is specifically configured to: determine some to-be-migrated applications from all the to-be-migrated applications as target applications; when the migration constraint is met, determine a candidate server that receives the target application, and migrate, to the candidate server corresponding to the target application, an application container in which the target application is located, to minimize a quantity of servers configured to receive the target application; and continue to determine some to-be-migrated applications from the remaining applications in the to-be-migrated applications and use the some to-be-migrated applications as new target applications, and when the migration constraint is met, determine a candidate server that receives the target application, and migrating an application container of the target application to a candidate server corresponding to the target application, to minimize a quantity of servers configured to receive the target application, until all the to-be-migrated applications are migrated to the candidate servers.

This specification further provides a non-transitory computer-readable storage medium. The storage medium stores a computer application, and the computer application can be configured to perform the application migration method.

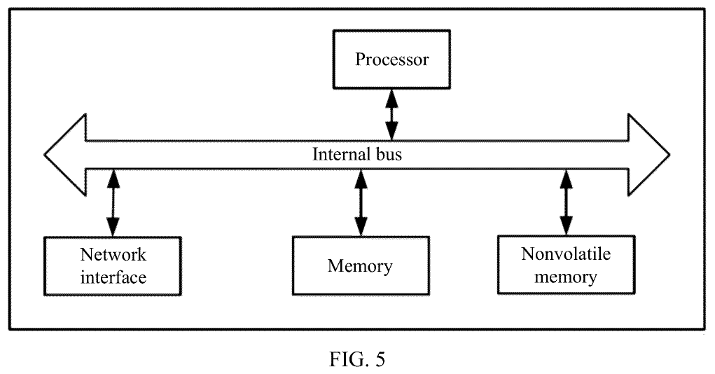

This specification further provides a schematic structural diagram illustrating an electronic device shown in FIG. 5. As shown in FIG. 5, in terms of hardware, the electronic device includes a processor, an internal bus, a network interface, a memory, and a nonvolatile memory, and certainly can further include hardware needed by another service. The processor reads a corresponding computer program from the nonvolatile memory into the memory and then runs the computer program, to implement the application migration method. Certainly, in addition to software implementations, another implementation is not excluded in this specification, for example, a logic device or a combination of hardware and software. In other words, an execution body of the following processing process is not limited to logical units, and can be hardware or a logic device.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. Almost all designers obtain a corresponding hardware circuit structure by programming an improved method procedure into a hardware circuit. Therefore, a method procedure can be improved using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and produce an application-specific integrated circuit chip. In addition, at present, instead of manually manufacturing an integrated circuit chip, this type of programming is mostly implemented by using “logic compiler” software. The programming is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. It should also be clear to a person skilled in the art that a hardware circuit for implementing a logical method procedure can be easily obtained by performing slight logic programming on the method procedure by using the above-mentioned several hardware description languages and programming the method procedure into an integrated circuit.

A controller can be implemented by using any appropriate method. For example, the controller can be a microprocessor or a processor, or a computer readable medium that stores computer-readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. The memory controller can also be implemented as a part of the control logic of the memory. A person skilled in the art also knows that in addition to implementing the controller by using only the computer-readable program code, logic programming can be performed on method steps to enable the controller to implement the same function in forms of the logic gate, the switch, the application-specific integrated circuit, the programmable logic controller, the built-in microcontroller, and the like. Therefore, the controller may be considered as a hardware component, and an apparatus included in the controller for implementing various functions may also be considered as a structure in the hardware component. Alternatively, the apparatus configured to implement various functions may even be considered as both a software module implementing the method and a structure in the hardware component.

The system, apparatus, module, or unit illustrated in the previous embodiments can be specifically implemented by using a computer chip or an entity, or can be implemented by using a product having a certain function. A typical implementation device is a computer. Specifically, the computer can be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above-mentioned apparatus is described by dividing functions into various units. Certainly, when this specification is implemented, functions of the units can be implemented in one or more pieces of software and/or hardware.

A person skilled in the art should understand that an embodiment of this specification can be provided as a method, a system, or a computer program product. Therefore, this specification can use a form of hardware only embodiments, software only embodiments, or embodiments with a combination of software and hardware. Moreover, this specification can use a form of a computer program product that is implemented on one or more computer-usable storage media (including but not limited to a disk memory, a CD-ROM, an optical memory, and the like) that include computer-usable program code.

This specification is described with reference to the flowcharts and/or block diagrams of the method, the device (system), and the computer program product based on the embodiments of this specification. It should be understood that computer program instructions can be used to implement each process and/or each block in the flowcharts and/or the block diagrams and a combination of a process and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate an apparatus for implementing a specific function in one or more processes in the flowcharts and/or in one or more blocks in the block diagrams.

Alternatively, these computer program instructions can be stored in a computer-readable storage that can instruct a computer or another programmable data processing device to work in a specific manner, so the instructions stored in the computer-readable storage generate an artifact that includes an instruction apparatus. The instruction apparatus implements a specific function in one or more procedures in the flowcharts and/or in one or more blocks in the block diagrams.

These computer program instructions can alternatively be loaded onto the computer or another programmable data processing device, so a series of operations and steps are performed on the computer or the another programmable device, thereby generating computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPUs), one or more input/output interfaces, one or more network interfaces, and one or more memories.

The memory can include a form of a volatile memory, a random access memory (RAM), a nonvolatile memory, and/or the like in a computer-readable medium, such as a read-only memory (ROM) or a flash memory (flash RAM). The memory is an example of the computer readable medium.

The computer-readable medium includes persistent, non-persistent, removable and non-removable media that can store information by using any method or technology. Information may be a computer-readable instruction, a data structure, a program module, or other data. Examples of the computer storage medium include but are not limited to a phase change random access memory (PRAM), a static random access memory (SRAM), a dynamic random access memory (DRAM), a random access memory (RAM) of another type, a read-only memory (ROM), an electrically erasable programmable read-only memory (EEPROM), a flash memory or another memory technology, a compact disc read-only memory (CD-ROM), a digital versatile disc (DVD) or another optical storage, a cassette, a cassette magnetic disk storage, or another magnetic storage device or any other non-transmission medium. The computer storage medium can be configured to store information that can be accessed by a computing device. Based on the definition in this specification, the computer-readable medium does not include transitory media such as a modulated data signal and carrier.

It should be further noted that the terms “include”, “comprise”, or any other variant thereof are intended to cover a non-exclusive inclusion, so that a process, a method, a product, or a device that includes a list of elements not only includes those elements but also includes other elements which are not expressly listed, or further includes elements inherent to such process, method, product, or device. Without more constraints, an element preceded by “includes a . . . ” does not preclude the existence of additional identical elements in the process, method, product or device that includes the element.

A person skilled in the art should understand that some embodiments of this specification can be provided as methods, systems, or computer program products. Therefore, a form of hardware only embodiments, software only embodiments, or embodiments with a combination of software and hardware can be used in this specification. Moreover, this specification can use a form of a computer program product that is implemented on one or more computer-usable storage media (including but not limited to a disk memory, a CD-ROM, an optical memory, and the like) that include computer-usable program code.

This specification can be described in the general context of computer-executable instructions, for example, a program module. Usually, the program module includes a routine, a program, an object, a component, a data structure, etc. executing a specific task or implementing a specific abstract data type. This specification can alternatively be practiced in distributed computing environments in which tasks are performed by remote processing devices that are connected through a communication network. In the distributed computing environments, the program module can be located in both local and remote computer storage media including storage devices.

The embodiments in this specification are described in a progressive manner. For the same or similar parts of the embodiments, references can be made to the embodiments. Each embodiment focuses on a difference from other embodiments. Particularly, the system embodiments are basically similar to the method embodiments, and therefore are described briefly. For related parts, references can be made to some descriptions in the method embodiments.

The above-mentioned descriptions are merely some embodiments of this specification and are not intended to limit this specification. A person skilled in the art can make various changes and variations to this specification. Any modification, equivalent replacement, or improvement made without departing from the spirit and principle of this specification shall fall within the scope of the claims in this specification.

What is claimed is:

1. An application migration method, comprising:
determining a to-be-migrated application comprised in a to-be-maintained server and all candidate servers that receive the to-be-migrated application;
for each to-be-migrated application, determining an application container configured to maintain the to-be-migrated application;
determining a migration constraint between all to-be-migrated applications and all the candidate servers; and
determining, from all the candidate servers when the migration constraint is satisfied and a quantity of servers configured to receive the to-be-migrated application meets a preset requirement, a server that receives each to-be-migrated application, and for each to-be-migrated application, migrating an application container of the to-be-migrated application to a server corresponding to the to-be-migrated application.

2. The method according to claim 1, wherein the determining each candidate server that receives the to-be-migrated application comprises:
determining, as the candidate server that receives the to-be-migrated application, a server that matches a server configuration of the to-be-maintained server.

3. The method according to claim 1, wherein the determining a migration constraint between all to-be-migrated applications and all the candidate servers comprises:
for each to-be-migrated application, determining, based on configuration information of each candidate server as a mutually exclusive server corresponding to the to-be-migrated application, a candidate server that does not match the to-be-migrated application; and
determining the migration constraint between all the to-be-migrated applications and the candidate servers based on the mutually exclusive server corresponding to the to-be-migrated application.

4. The method according to claim 1, wherein before the determining, from all the candidate servers when the migration constraint is satisfied and a quantity of servers configured to receive the to-be-migrated application meets a preset requirement, a server that receives each to-be-migrated application, the method further comprises:
determining a service constraint existing between all the to-be-migrated applications; and
the determining, from all the candidate servers when the migration constraint is satisfied and a quantity of servers configured to receive the to-be-migrated application meets a preset requirement, a server that receives each to-be-migrated application comprises:
when the migration constraint and the service constraint are satisfied and the quantity of servers configured to receive the to-be-migrated application meets the preset requirement, determining, from all the candidate servers, the server that receives each to-be-migrated application.

5. The method according to claim 4, wherein the determining a service constraint existing between all the to-be-migrated applications comprises:
determining a service peak period corresponding to each to-be-migrated application;
for each to-be-migrated application, determining a mutually exclusive application corresponding to the to-be-migrated application based on the service peak period corresponding to each to-be-migrated application; and
determining the service constraint between all the to-be-migrated applications based on mutually exclusive applications corresponding to all the to-be-migrated applications.

6. The method according to claim 1, wherein the determining, from all the candidate servers when the migration constraint is satisfied and a quantity of servers configured to receive the to-be-migrated application meets a preset requirement, a server that receives each to-be-migrated application, and for each to-be-migrated application, migrating an application container of the to-be-migrated application to a server corresponding to the to-be-migrated application comprises:
determining some to-be-migrated applications from all the to-be-migrated applications as target applications;
when the migration constraint is met, determining a candidate server that receives the target application, and migrating, to the candidate server corresponding to the target application, an application container in which the target application is located, to minimize a quantity of servers configured to receive the target application; and
continuing to determine some to-be-migrated applications from the remaining applications in the to-be-migrated applications and use the some to-be-migrated applications as new target applications, and when the migration constraint is met, determining a candidate server that receives the target application, and migrating an application container of the target application to a candidate server corresponding to the target application, to minimize a quantity of servers configured to receive the target application, until all the to-be-migrated applications are migrated to the candidate servers.

7. A non-transitory computer-readable storage medium, comprising instructions stored therein that, when executed by a processor of a computing device, cause the processor to:
determine a to-be-migrated application comprised in a to-be-maintained server and all candidate servers that receive the to-be-migrated application;
for each to-be-migrated application, determine an application container configured to maintain the to-be-migrated application;
determine a migration constraint between all to-be-migrated applications and all the candidate servers; and
determine, from all the candidate servers when the migration constraint is satisfied and a quantity of servers configured to receive the to-be-migrated application meets a preset requirement, a server that receives each to-be-migrated application, and for each to-be-migrated application, migrate an application container of the to-be-migrated application to a server corresponding to the to-be-migrated application.

8. An electronic device, comprising a processor and a memory, wherein the memory stores executable instructions that, in response to execution by the processor, cause the processor to:
determine a to-be-migrated application comprised in a to-be-maintained server and all candidate servers that receive the to-be-migrated application;
for each to-be-migrated application, determine an application container configured to maintain the to-be-migrated application;
determine a migration constraint between all to-be-migrated applications and all the candidate servers; and
determine, from all the candidate servers when the migration constraint is satisfied and a quantity of servers configured to receive the to-be-migrated application meets a preset requirement, a server that receives each to-be-migrated application, and for each to-be-migrated application, migrate an application container of the to-be-migrated application to a server corresponding to the to-be-migrated application.
